(19) United States
(12) Patent Application Publication
(10) Pub. No.: US 2021/0148573 A1
(43) Pub. Date: May 20, 2021

(54) GAS TURBINE COMBUSTOR

(71) Applicant: TOSHIBA ENERGY SYSTEMS & SOLUTIONS CORPORATION, Kawasaki-shi (JP)

(72) Inventors: Parikshit JAIN, Yokohama (JP); Yasunori IWAI, Yokohama (JP); Yuichi MORISAWA, Yokohama (JP); Masao ITOH, Yokohama (JP)

(73) Assignee: TOSHIBA ENERGY SYSTEMS & SOLUTIONS CORPORATION, Kawasaki-shi (JP)

(21) Appl. No.: 16/683,582

(22) Filed: Nov. 14, 2019

(51) Int. Cl. F23R 3/00; F01D 9/02

(52) U.S. Cl. CPC F23R 3/002; F01D 9/023; F05D 2260/941; F05D 2240/35; F23R 2900/03043

(57) ABSTRACT

The embodiment prevents the buckling of a combustor liner without causing any increase in thermal stress when applied to a plant that uses supercritical carbon dioxide as a working fluid. A gas turbine combustor includes: a fuel nozzle; a cylindrical combustor liner provided downstream of the fuel nozzle; and a transition piece provided downstream of the combustor liner to guide a fuel gas to a gas turbine stator blade, wherein the combustor liner is divided into and composed of a plurality of liner composing members which are coupled in an axial direction.

### FIELD

Embodiments of the present invention relate to a gas turbine combustor.

### BACKGROUND

In gas turbine facilities used for power generation and the like, gas turbine combustors where the combustion of a fuel takes place have been conventionally used. As illustrated in FIG. 15, a gas turbine combustor 200 includes a fuel nozzle 201 on its upstream side, a combustor liner 202 provided downstream of the fuel nozzle 201, and a transition piece 203 provided downstream of the combustor liner 202 to guide a combustion gas to gas turbine stator blades 150.

In the conventional gas turbine combustor 200, the combustor liner 202 is constituted by a single cylindrical component and is connected with the transition piece 203 through a spring seal 204 or the like. In the combustor liner 202, a high-temperature combustion gas generated by the combustion of a fuel is guided to the gas turbine stator blades 150 through the transition piece 203. Usually, a differential pressure that is about 3% to 5% of a combustor inlet pressure acts on the combustor liner 202 of the gas turbine combustor 200, but an operating pressure of conventional gas turbines does not cause a problem of buckling.

Studies have been made in recent years on a power generation plant using supercritical carbon dioxide as a working fluid of a turbine. In this power generation plant, the temperature of the working fluid at an inlet of the turbine is over 1000° C. and an operating pressure reaches about 30 MPa.

The operating pressure in conventional gas turbine combustors is about 2 MPa. On the other hand, as described above, in the example of the gas turbine combustor using the supercritical carbon dioxide as the working fluid, the operating pressure is about 30 MPa, which is about 15 times the conventional operating pressure. Accordingly, in the gas turbine combustor using the supercritical carbon dioxide as the working fluid, a differential pressure that acts on its combustor liner is also as large as about 15 times, and the problem of buckling of the combustor liner occurs.

Further, a high-temperature combustion gas flows in the combustor liner and causes a problem such as burnout of liner metal unless it is cooled. To solve the problem, a low-temperature cooling gas is made to flow on the outer surface of the combustor liner to cool the liner metal. This causes a temperature difference between the inner surface and the outer surface of the combustor liner because the inner surface has a high temperature and the outer surface has a low temperature. This temperature difference, if large, causes a difference in thermal expansion to cause thermal stress, leading to damage to the combustor liner. Since increasing the plate thickness of the combustor liner for the purpose of preventing buckling results in a large temperature difference between the inner and outer surfaces to excessively increase the thermal stress, it is difficult to prevent buckling by increasing the plate thickness of the combustor liner.

As described above, if the gas turbine combustor is applied to the plant using the supercritical dioxide as the working fluid, the problem of buckling occurs due to the large differential pressure acting on the combustor liner. Increasing the plate thickness to avoid this buckling results in an increase in thermal stress, leading to the damage to the combustor liner. Therefore, it is difficult to solve the problem of buckling only by changing the plate thickness.

It is an object of the present invention to provide a gas turbine combustor that enables to prevent the buckling of a combustor liner without causing any increase in thermal stress when the gas turbine combustor is applied to a plant that uses supercritical dioxide as a working fluid.

### BRIEF DESCRIPTION OF THE DRAWINGS

FIG. 1 is a system diagram of a gas turbine facility including a gas turbine combustor of embodiments.

FIG. 2 is a vertical sectional view illustrating the structure of an essential part of a gas turbine combustor of a first embodiment.

FIG. 3 is a graph representing a relation between the plate thickness of a combustor liner and value C equal to buckling stress divided by a load.

FIG. 4 is a view schematically illustrating the state of an inner part and an outer surface of the combustor liner.

FIG. 5 is a graph representing relations of the plate thickness of the combustor liner with liner metal temperature and thermal stress.

FIG. 6 is a graph representing a relation between the length of the combustor liner and the value C equal to the buckling stress divided by the load.

FIG. 7 is a graph representing a relation between the diameter of the combustor liner and the value C equal to the buckling stress divided by the load.

FIG. 8 is a graph representing Young's modulus dependence of the relation between the length of the combustor liner and the value C equal to the buckling stress divided by the load.

FIG. 9 is a graph representing a relation between the length of the combustor liner and the value C equal to the buckling stress divided by the load.

FIG. 10 is a vertical sectional view illustrating the structure of an essential part of a gas turbine combustor of a second embodiment.

FIG. 11 is a graph representing a relation between the length of a combustor liner and value C equal to buckling stress divided by a load.

FIG. 12 is a vertical sectional view illustrating the structure of an essential part of a gas turbine combustor of a third embodiment.

FIG. 13 is a front view illustrating the structure of a liner composing member in FIG. 12.

FIG. 14 is a vertical sectional view illustrating the structure of an essential part of a gas turbine combustor of a fourth embodiment.

FIG. 15 is a vertical sectional view illustrating an example of the structure of an essential part of a conventional gas turbine combustor.

### DETAILED DESCRIPTION

A gas turbine combustor of embodiments includes a fuel nozzle, a cylindrical combustor liner provided downstream of the fuel nozzle, and a transition piece provided downstream of the combustor liner to guide a fuel gas to a gas turbine stator blade. The combustor liner is divided into and composed of a plurality of liner composing members which are coupled in an axial direction.

The embodiments of the present invention will be hereinafter described with reference to the drawings.

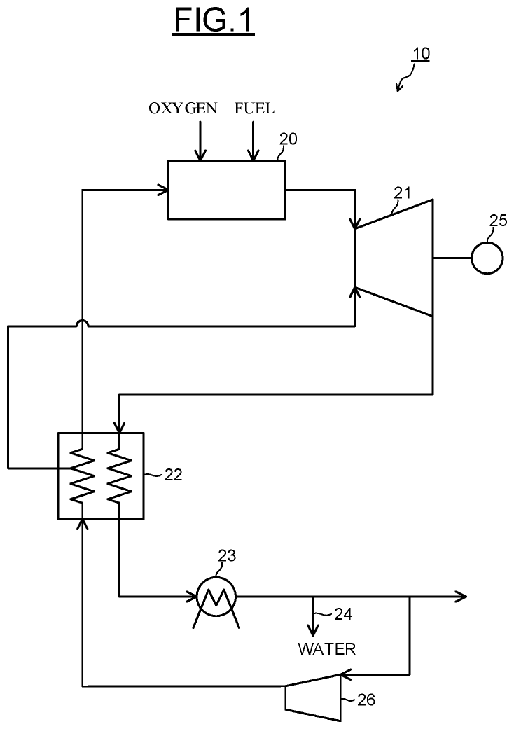

FIG. 1 is a system diagram of a gas turbine facility 10 including the gas turbine combustor of the embodiments. The gas turbine facility 10 uses a CO₂ turbine.

As illustrated in FIG. 1, oxygen and a fuel are supplied to the gas turbine combustor 20 to burn. Carbon dioxide which is to circulate as a working fluid is also introduced to the gas turbine combustor 20. Flow rates of the fuel and the oxygen are adjusted such that, for example, their ratio in a completely mixed state becomes a stoichiometric mixture ratio (theoretical mixture ratio). The fuel is, for example, a natural gas, a hydrocarbon such as methane, or a coal gasification gas.

A combustion gas made up of carbon dioxide and water vapor, which are generated by the combustion, and the carbon dioxide which is the working fluid is discharged from the gas turbine combustor 20 and is introduced to a turbine 21. The combustion gas having performed expansion work in the turbine 21 passes through a heat exchanger 22 and further through a heat exchanger 23. When the combustion gas passes through the heat exchanger 23, the water vapor is condensed into water. The water is discharged outside through a pipe 24. Incidentally, a power generator 25 is coupled to the turbine 21.

The dry working gas (carbon dioxide) separated from the water vapor is increased in pressure in a compressor 26 to be a supercritical fluid. At an outlet of the compressor 26, the dry working gas has a pressure of, for example, about 30 MPa.

Part of the dry working gas increased in pressure in the compressor 26 is heated in the heat exchanger 22 and is supplied as the working fluid to the gas turbine combustor 20. The dry working gas introduced to the gas turbine combustor 20 is, for example, jetted to a combustion zone from an upstream side of the gas turbine combustor 20 together with the fuel and an oxidizer, or is jetted from a dilution hole or the like to a downstream side of the combustion zone in a combustor liner after the combustor liner is cooled.

Further, part of the dry working fluid which is the supercritical fluid is introduced as a cooling medium to the turbine 21 through a pipe branching off from the middle of a flow path in the heat exchanger22. The temperature of the cooling medium is preferably, for example, about 350° C. to about 550° C., considering a cooling effect and thermal stress generated in a cooling target.

The remainder of the dry working gas having worked in the turbine 21 and deprived of the water in the pipe 24 is discharged to the outside of the system. The dry working gas discharged outside is, for example, recovered by a recovery device. The dry working gas discharged outside can also be used, for instance, in EOR (Enhanced Oil Recovery) or the like used in an oil drilling site. In the above-described system, for example, carbon dioxide whose amount corresponds to a generation amount of the carbon dioxide generated by the combustion of the fuel and the oxygen in the gas turbine combustor 20 is discharged to the outside of the system.

### First Embodiment

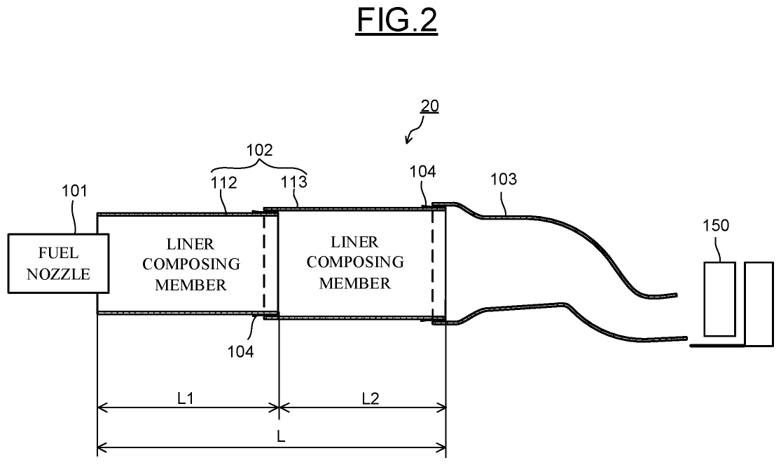

Next, the structure of a gas turbine combustor 20 according to a first embodiment will be described. FIG. 2 is a sectional view illustrating the structure of an essential part of the gas turbine combustor 20 according to the first embodiment. As illustrated in FIG. 2, the gas turbine combustor 20 includes a fuel nozzle 101, a cylindrical combustor liner 102 provided downstream of the fuel nozzle 101, and a transition piece 103 provided downstream of the combustor liner 102 to guide a fuel gas to gas turbine stator blades 150. The inside of the combustor liner 102 forms a combustion chamber where the combustion of a fuel and oxygen takes place. The outer side of the combustor liner 102 is covered with a not-illustrated gas turbine outer cylinder with a gap therebetween.

The combustor liner 102 is divided into and composed of two liner composing members 112, 113 which are coupled in the axial direction. That is, the two liner composing member 112 (length L1) and liner composing member 113 (length L2) which are shorter than a predetermined axial-direction length L required of the combustor liner 102 are coupled so that the whole combustor liner 102 has the length L.

In the liner composing member 113, the inside diameter of an end portion connected with the liner composing member 112 is larger than the outside diameter of an end portion of the liner composing member 112. The liner composing member 113 and the liner composing member 112 are connected with each other, with the aforesaid end portion of the liner composing member 113 located on the outer side of the end portion of the liner composing member 112 in an overlapping manner. For this connection, a spring seal 104 is used. The inside diameter of the liner composing member 113 may be larger only at the end portion connected with the liner composing member 112, or the inside diameter of the whole liner composing member 113 may be larger. Since the liner composing member 113 is disposed with its end portion overlapping with the outer side of the liner composing member 112, its actual length is longer than L2 by the length of the overlapping portion.

The spring seal 104 is annular and its inside diameter is set so as to fit the outside diameter of the liner composing member 112. The spring seal 104 is partly fixed to the liner composing member 112 by welding or the like. It is fit while pressing an inner wall side of the liner composing member 113 due to the elasticity of its spring, and when the liner composing member 112 and the liner composing member 113 thermally expand in the axial direction, they slide, whereby stress can be absorbed. A connection method other than the spring seal 104 can be to use a ring-shaped member such as a piston ring.

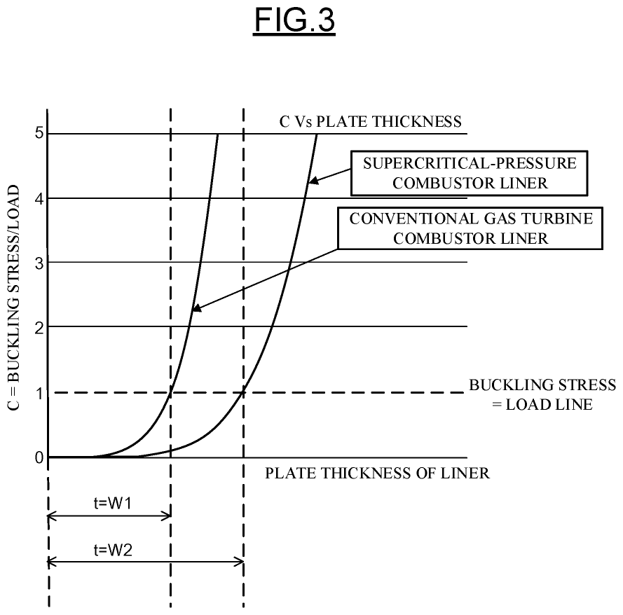

A reason why the above-described structure is adopted in the first embodiment will be described in detail below. The graph in FIG. 3 represents a relation between the plate thickness of the combustor liner and value C equal to buckling stress divided by a load (load due to a differential pressure acting on the combustor liner), with the former taken on the horizontal axis and with the latter taken on the vertical axis, and represents the comparison result between a case of a conventional gas turbine combustor liner (about 2 MPa operating pressure) and a case of a supercritical pressure combustor liner (about 30 MPa operating pressure). In the case where the aforesaid value C is smaller than 1, there is a possibility of the occurrence of buckling. The two curves illustrated in FIG. 3 are found from a later-described theoretical formula and indicate that the large plate thickness prevents the occurrence of buckling.

In the case where the operating pressure is large and accordingly the differential pressure acting on the combustor liner is also large, C on the vertical axis is smaller even if the plate thickness is the same, which indicates that buckling is more likely to occur. When the plate thickness is W1, buckling does not occur in the case of the conventional operating pressure of 2 MPa, while, in the case of the operating pressure of 30 MPa, the C value is far below 1, which indicates that buckling occurs. To avoid buckling in the case of the operating pressure of 30 MPa, the plate thickness needs to be increased to W2.

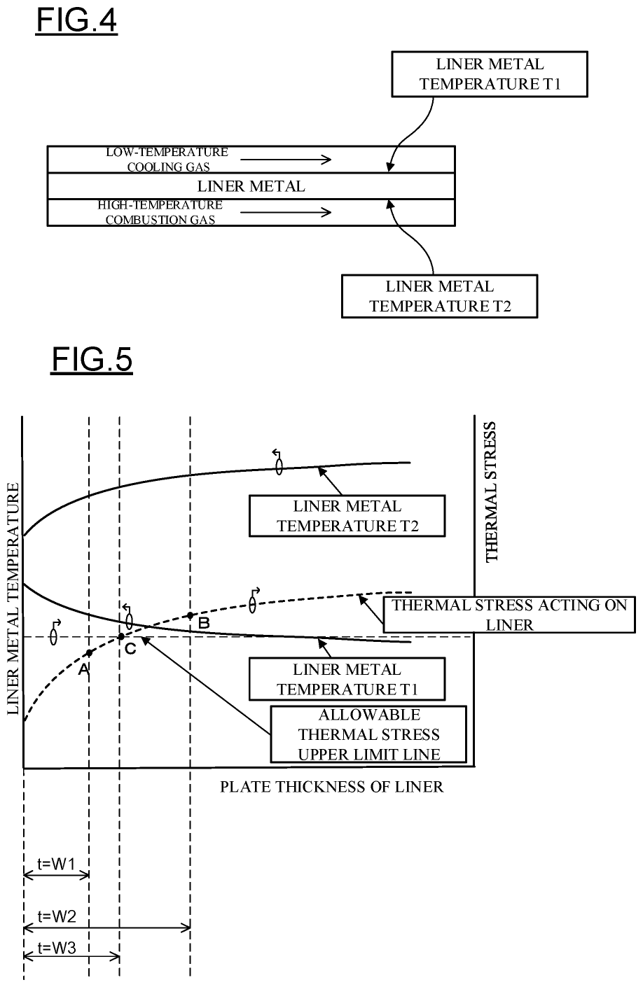

A high-temperature combustion gas flows inside the combustor liner, and the problem such as burning occurs in the liner metal unless it is cooled as previously described. To avoid this, a low-temperature cooling gas is made to flow on the outer surface of the liner metal of the combustor liner as illustrated in FIG. 4 to cool the liner metal. This causes a temperature difference between the inner surface and the outer surface of the combustor liner because the inner surface has a high temperature (T2) and the outer surface has a low temperature (T1). This temperature difference, if large, causes a difference in thermal expansion to cause thermal stress, leading to damage to the liner.

The graph in FIG. 5 is to explain the temperature of the liner and the acting thermal stress, with the plate thickness of the combustor liner taken on the horizontal axis, the temperature of the liner metal taken on the left vertical axis, and the thermal stress taken on the right vertical axis. With an increase in the plate thickness, the inner surface temperature T2 increases and the outer surface temperature T1 decreases. From this, it is seen that the increase in the plate thickness causes an increase in the temperature difference T2−T1 to increase the thermal stress. In the graph in FIG. 5, an allowable thermal stress upper limit line is indicated by the broken line. The thermal stress corresponding to the plate thickness W1 of the conventional gas turbine is at A point, which is below the allowable thermal stress.

If the plate thickness of the combustor liner is increased to the plate thickness W2 indicated in FIG. 3 to avoid buckling, the thermal stress has a value at B point, which is over the allowable thermal stress upper limit line as illustrated in the graph in FIG. 5. Therefore, only increasing the plate thickness of the combustor liner cannot be a solution to the problem of the buckling of the combustor liner. Incidentally, the plate thickness corresponding to the limit C where the thermal stress intersects with the allowable thermal stress upper limit line is W3 indicated in FIG. 5.

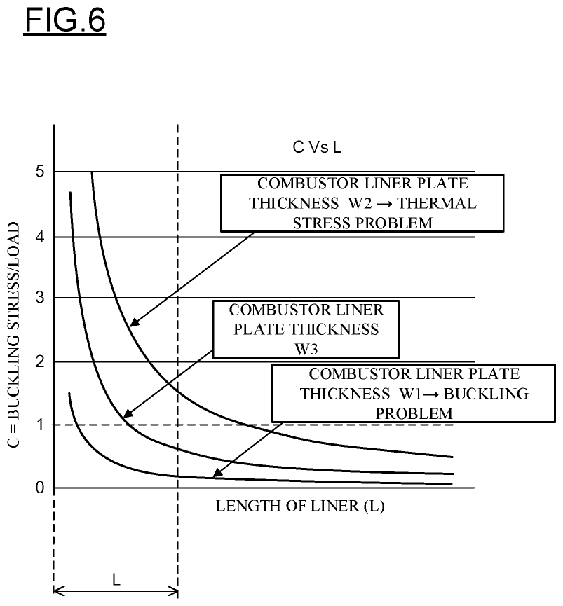

The graph in FIG. 6 represents a relation between the length (L) of the combustor liner and the aforesaid C value (value equal to the buckling stress divided by the load (load due to the differential pressure acting on the combustor liner), with the former taken on the horizontal axis and the latter taken on the vertical axis. The three curves illustrated in the graph in FIG. 6 are found from the later-described theoretical formula under the supercritical pressure condition. Further, L in the graph is a length that the liner combustor needs to have for completing the combustion in the gas turbine combustor.

Out of the three curves illustrated in the graph in FIG. 6, in the curve of the case where the plate thickness of the combustor liner is the large plate thickness W2, the C value is 1 or more even if the length of the combustor liner is L, but there is a problem of the thermal stress as previously described. Further, it is seen that, in the case of the plate thickness W1 which is equal to the plate thickness of the conventional combustor liner, the C value is far smaller than 1 and thus buckling occurs. In the case of the plate thickness W3 found from the allowable thermal stress upper limit indicated in the graph in FIG. 5 as well, it is seen that buckling occurs if the length is L.

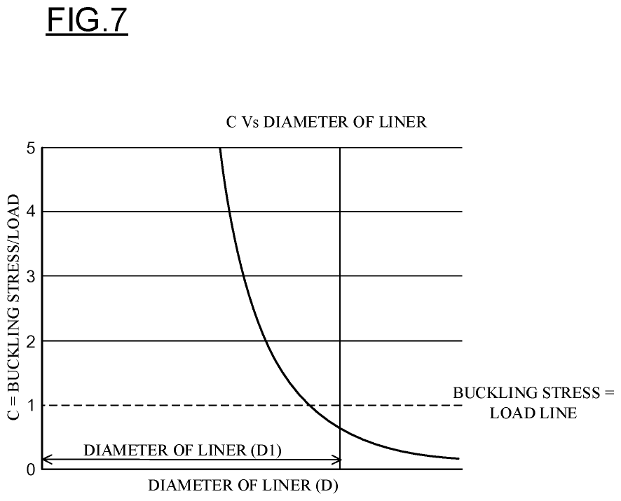

The graph in FIG. 7 represents a relation between the diameter (D) of the combustor liner and the aforesaid C value (value equal to the buckling stress divided by the load (load due to the differential pressure acting on the combustor liner)), with the former taken on the horizontal axis and the latter taken on the vertical axis. The curve illustrated in FIG. 7 is obtained under the supercritical pressure condition. As illustrated in FIG. 7, setting the diameter of the combustor liner small makes it possible to avoid buckling. However, buckling occurs if its diameter is set to a required liner diameter (D1) that is determined by design conditions such as an output of the gas turbine, a working fluid amount, a cross-sectional average velocity in the combustor, the number of cans, and a combustion load.

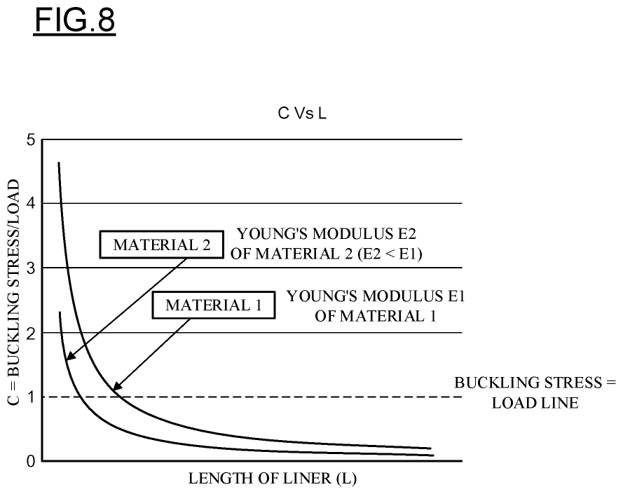

The graph in FIG. 8 represents a relation between the length (L) of the combustor liner and the aforesaid C value (value equal to the buckling stress divided by the load (load due to the differential pressure acting on the combustor liner)), with the former taken on the horizontal axis and the latter taken on the vertical axis. The two curves illustrated in FIG. 8 are obtained under the supercritical pressure condition, and represent the relation found in two kinds of materials different in Young's modulus (Young's modulus E1 of the material 1>Young's modulus E2 of the material 2). As is seen in FIG. 8, buckling does not easily occur if the material high in Young's modulus is selected. However, the material of the combustor liner must endure high temperatures, and it is difficult to give the highest priority to the Young's modulus in selecting the material.

The theoretical formula for finding the curves illustrated in the above-described graphs is as follows.

F_{reL}=C_{θL}[π²E/12(1−ν²)](t/L)²

F_{reL}=buckling stress

C_{θL}=buckling coefficient

ν=Poisson's ratio

E=Young's modulus

t=thickness of the combustor liner

L=length of the combustor liner

Further, the following relation holds:

buckling stress∝(Young's modulus of material/[{(r/t)^{2.5}}×(L/r)], where r=the inside radius of the combustor liner.

As described above, it is difficult to avoid buckling by adjusting the thickness, the inside diameter, the material, and so on of the combustor liner. Therefore, in the first embodiment, as a method to prevent buckling from occurring at the supercritical pressure in the liner having a plate thickness decided according to the limitation by the thermal stress, the combustor liner 102 is divided into and composed of the two liner composing members 112, 113 which are coupled in the axial direction.

In the first embodiment, the division number is 2, but the division number is determined by a relation of the length L required of the combustor liner, the thickness t determined by the limitation by the thermal stress, and the buckling curve of the material. Reducing the division number reduces the number of portions joined using the spring seals or the like, enabling to reduce an amount of a fluid leaking from the outside of the liner into the combustor, and therefore, the division number is preferably the minimum necessary number.

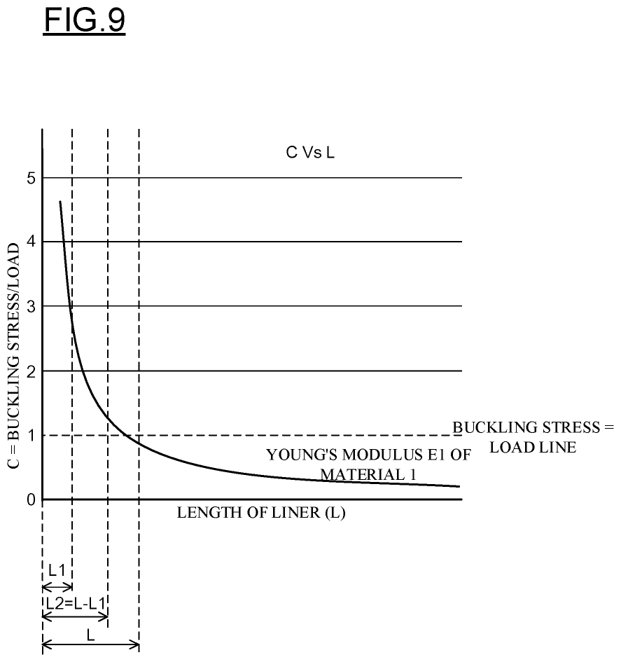

The graph in FIG. 9 represents a relation between the length (L) of the combustor liner and the aforesaid C value (value equal to the buckling stress divided by the load (load due to the differential pressure acting on the combustor liner)), with the former taken on the horizontal axis and the latter taken on the vertical axis. In a gas turbine combustor used at the supercritical pressure, if its combustor liner having the length L is composed of one component, a differential pressure acting on the liner is large and the load exceeds the allowable buckling stress (the C value becomes smaller than 1), resulting in buckling.

On the other hand, as is seen in FIG. 9, in the cases where the length is set to L1, L2 shorter than L, the load is below the allowable buckling stress (the C value is larger than 1), making it possible to avoid buckling. Therefore, by two-dividing the liner into one having the length L1 and one having the length L2 and coupling these to make the total length L=L1+L2 or the like, it is possible to avoid buckling. Incidentally, as illustrated in FIG. 2, in the first embodiment, the liner composing member 112 and the liner composing member 113 which are substantially equal in length are coupled in the axial direction to form the combustor liner 102.

As described above, in the first embodiment, since the two liner composing members 112, 113 are coupled in the axial direction to form the single combustor liner 102, the liner composing member 112 and the liner composing member 113 can each have such a length that buckling does not occur even when they are used at the supercritical pressure. Further, they can each have such a plate thickness that the thermal stress becomes equal to or less than the allowable thermal stress. Incidentally, the inside diameter D and the length L of the combustor liner 102 are decided to appropriate values according to the aforesaid design conditions, the length of the combustion zone, and so on. The buckling curve is determined by the relation of the inside diameter D and the length L, and the material used.

### Second Embodiment

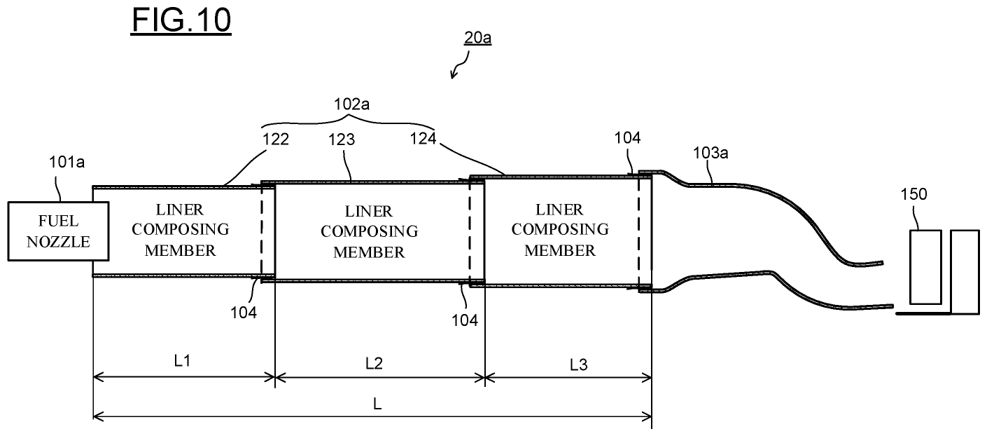

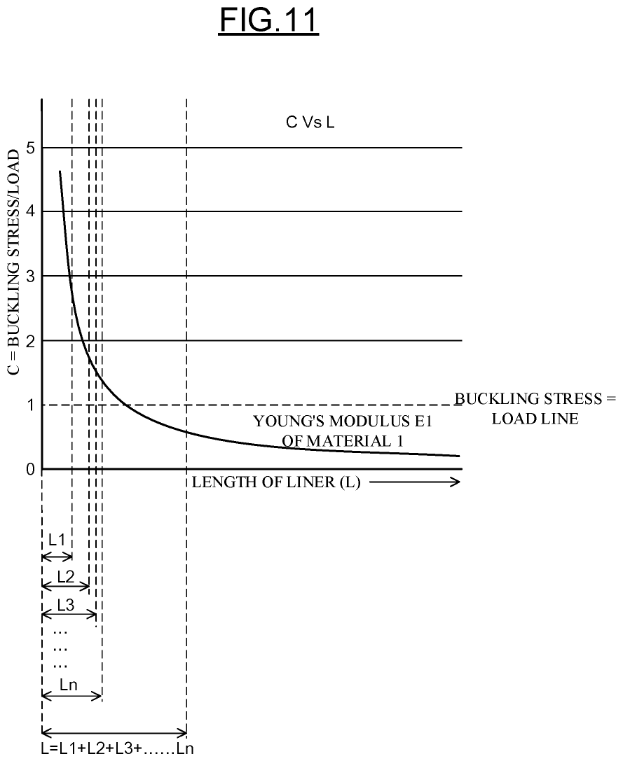

Next, the structure of a gas turbine combustor 20a according to a second embodiment will be described. FIG. 10 is a vertical sectional view illustrating the structure of an essential part of the gas turbine combustor 20a according to the second embodiment. As illustrated in FIG. 10, the gas turbine combustor 20a includes a fuel nozzle 101a, a cylindrical combustor liner 102a provided downstream of the fuel nozzle 101a, and a transition piece 103a provided downstream of the combustor liner 102a to guide a combustion gas to gas turbine stator blades 105.

The combustor liner 102a is divided into and composed of three liner composing members 122, 123, and 124 which are coupled in the axial direction. That is, the three liner composing members 122, 123, 124 which are shorter than a predetermined axial-direction length L required of the combustor liner 102a are coupled so that the whole combustor liner 102a has the length L.

In the liner composing member 123 located at the middle out of the three, the inside diameter of an end portion connected with the liner composing member 122 located upstream is larger than the outside diameter of an end portion of the liner composing member 122. The liner composing member 123 and the liner composing member 122 are connected with each other, with this end portion of the liner composing member 123 located on the outer side of the end portion of the liner composing member 122 in an overlapping manner. For this connection, a spring seal 104 or the like is usable as in the first embodiment. The inside diameter of the liner composing member 123 may be larger only at the end portion connected with the liner composing member 122, or the inside diameter of the whole liner composing member 123 may be larger.

In the liner composing member 124 located most downstream, the inside diameter of an end portion connected with the liner composing member 123 is larger than the outside diameter of an end portion of the liner composing member 123. The liner composing member 124 and the liner composing member 123 are connected with each other, with this end portion of the liner composing member 124 located on the outer side of the end portion of the liner composing member 123 in an overlapping manner. For this connection, a spring seal 104 or the like is usable as in the first embodiment. The inside diameter of the liner composing member 124 may be larger only at the end portion connected with the liner composing member 123, or the inside diameter of the whole liner composing member 124 may be larger.

The inside diameter D and the length L of the combustor liner are decided to appropriate values according to the length of a combustion zone, a combustion load, and so on. A relation between the inside diameter D and the length L, and a material used determine a buckling curve. The axial-direction division number of the combustor liner is sometimes set larger than two depending on the necessary length L, the buckling curve, and a plate thickness found from thermal stress. In this case, the division number can be n, that is, L=L1+L2+L3+ . . . +Ln, where L is the necessary length of the liner. As illustrated in FIG. 10, in the second embodiment, the division number is 3 and L=L1+L2+L3. Incidentally, since the liner composing member 123 is disposed with its end portion overlapping with the outer side of the liner composing member 122, its actual length is longer than L2 by the length of the overlapping portion as in the first embodiment. Similarly, since the liner composing member 124 is disposed with its end portion overlapping with the outer side of the liner composing member 123, its actual length is longer than L3 by the length of the overlapping portion.

The graph in FIG. 11 represents a relation between the length (L) of the combustor liner and the aforesaid C value (value equal to the buckling stress divided by the load (load due to the differential pressure acting on the combustor liner), with the former taken on the horizontal axis and the latter taken on the vertical axis. L1, L2, L3, . . . Ln in FIG. 11 are the lengths of the liner composing members into which the combustor liner is divided. As is seen in FIG. 11, the lengths of the liner composing members can be set to L1, L2, L3, . . . Ln such that the load applied thereto does not become equal to or more than the buckling stress.

### Third Embodiment

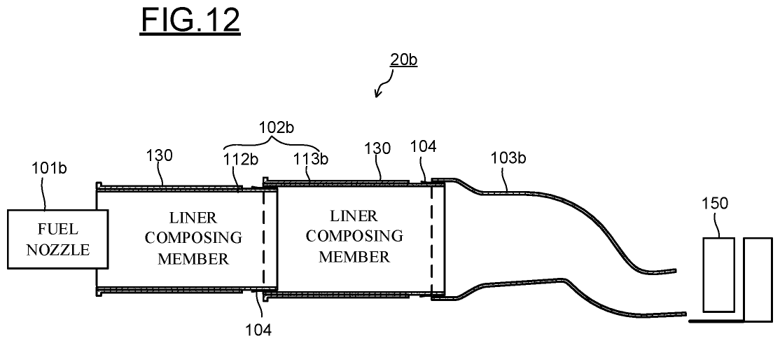

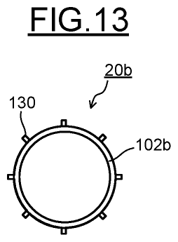

Next, the structure of a gas turbine combustor 20b according to a third embodiment will be described. FIG. 12 is a vertical sectional view illustrating the structure of an essential part of the gas turbine combustor 20b according to the third embodiment, and FIG. 13 is a front view of a liner composing member. As illustrated in FIG. 12, the gas turbine combustor 20b includes a fuel nozzle 101b, a cylindrical combustor liner 102b provided downstream of the fuel nozzle 102b, and a transition piece 103b provided downstream of the combustor liner 102b to guide a combustion gas to gas turbine stator blades 150.

In the gas turbine combustor 20b according to the third embodiment, the combustor liner 102b is divided into and composed of two liner composing members 112b, 113b which are coupled in the axial direction, as in the first embodiment. Besides, in the third embodiment, reinforcing ribs 130 are provided on the outer periphery of the combustor liner 102b (outer peripheries of the liner composing member 112b and the liner composing member 113b). The reinforcing ribs 130 are intended to attain a structure that does not easily buckle. This structure is applicable to a case where buckling may occur even if the combustor liner is multiply divided or a case where the division number needs to be reduced.

In the example illustrated in FIG. 12 and FIG. 13, the reinforcing ribs 130a are long in the axial direction and are attached to a plurality of places apart from one another in the circumferential direction. Instead, annular reinforcing ribs may be each attached along the circumferential direction and may be provided at a plurality of places apart from one another in the axial direction. Another example of an adoptable method is to form a plurality of projections in a convex shape on the liner surface. The reinforcing ribs 130 can be formed of the same material as that of the liner composing members 112b, 113b. Further, the size of the reinforcing ribs 130 may be appropriately selected according to required strength.

### Fourth Embodiment

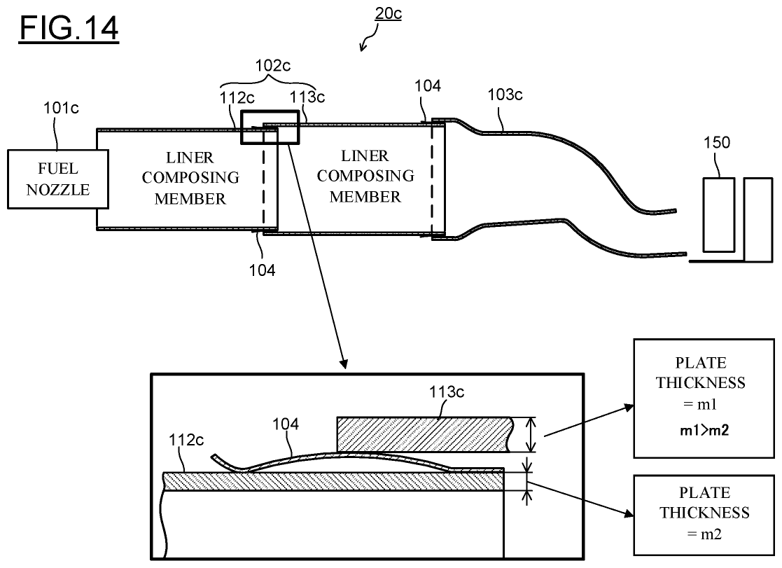

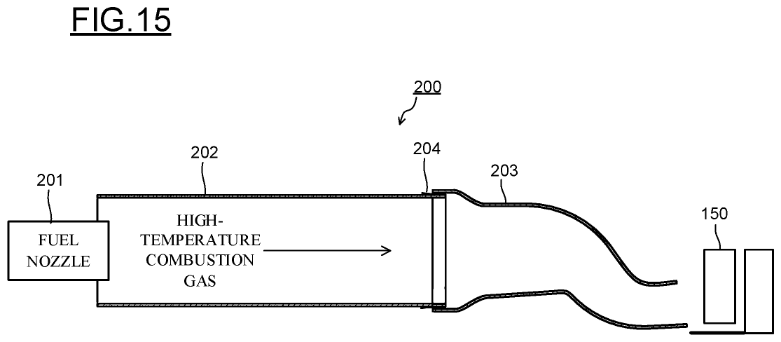

Next, the structure of a gas turbine combustor 20c according to a fourth embodiment will be described. FIG. 14 is a vertical sectional view illustrating the structure of an essential part of the gas turbine combustor 20c according to the fourth embodiment, and part thereof is illustrated in an enlarged manner in the enlarged view in the lower part in FIG. 14. As illustrated in FIG. 14, the gas turbine combustor 20c includes a fuel nozzle 101c, a cylindrical combustor liner 102c provided downstream of the fuel nozzle 102c, and a transition piece 103c provided downstream of the combustor liner 102c to guide a combustion gas to gas turbine stator blades 150.

In the gas turbine combustor 20c according to the fourth embodiment, the combustor liner 102c is divided into and composed of two liner composing members 112c, 113c which are coupled in the axial direction. That is, the two liner composing members 112c, 113c which are shorter than a predetermined axial-direction length L required of the combustor liner 102c are coupled so that the whole combustor liner 102c has the length L.

In the liner composing member 113c, the inside diameter of an end portion connected with the liner composing member 112c is larger than the outside diameter of an end portion of the liner composing member 112c. The liner composing member 113c and the liner composing member 112c are connected with each other, with this end portion of the liner composing member 113c located on the outer side of the end portion of the liner composing member 112c in an overlapping manner. For this connection, a spring seal 104 or the like is used as in the first embodiment. As is seen from a connection portion of the liner composing member 112c and the liner composing member 113c, which is illustrated in the enlarged view in FIG. 14, in the end portion of the liner composing member 113c located on the outer side, a portion overlapping with the liner composing member 112c has a plate thickness m1 larger than a plate thickness m2 of the liner composing member 112c.

By thus making the plate thickness of the liner composing member 113c on the outer side at the connection portion of the liner composing members larger, it is possible to make buckling difficult to occur. Being surrounded by a low-temperature cooling fluid, the liner composing member 113c on the outer side is free from a concern about thermal stress and is allowed to have a large thickness. By thus making the thickness of the liner composing member 113c on the outer side at the connection portion large, it is possible to increase the whole rigidity to make the buckling limit high.

As has been described hitherto, according to the above-described embodiments, it is possible to prevent the buckling of the combustor liner without causing any increase in thermal stress when these embodiments are applied to a plant using supercritical carbon dioxide as a working fluid.

While certain embodiments of the present invention have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### REFERENCE SIGNS LIST

10 . . . gas turbine facility, 20, 20a, 20b, 20c, 200 . . . gas turbine combustor, 21 . . . turbine, 22, 23 . . . heat exchanger, 24 . . . pipe, 25 power generator, 26 . . . compressor, 101, 101a, 101b, 101c, 102c, 201 . . . fuel nozzle, 102, 102a, 102b, 102c, 202 . . . combustor liner, 103, 103a, 103b, 103c, 203 . . . transition piece, 104, 204 spring seal, 112, 112c, 113, 113c, 122, 123, 124 liner composing member, 130 reinforcing rib, 150 gas turbine stator blade

What is claimed is:

1. A gas turbine combustor comprising:
a fuel nozzle;
a cylindrical combustor liner provided downstream of the fuel nozzle; and
a transition piece provided downstream of the combustor liner to guide a fuel gas to a gas turbine stator blade,
wherein the combustor liner is divided into and composed of a plurality of liner composing members which are coupled in an axial direction.

2. The gas turbine combustor according to claim 1,
wherein the combustor liner is two-divided into and composed of the liner composing members which are coupled in the axial direction.

3. The gas turbine combustor according to claim 1,
wherein, at a connection portion where the liner composing members are coupled, an end portion of one of the liner composing members is located on an outer peripheral side of an end portion of the other liner composing member in an overlapping manner, and in a gap between the end portions, a spring seal or a ring-shaped member is fit.

4. The gas turbine combustor according to claim 3,
wherein the end portion of the liner composing member located on the outer peripheral side is larger in thickness than the end portion of the other liner composing member located on an inner side.

5. The gas turbine combustor according to claim 1,
wherein a plurality of reinforcing ribs each extending in the axial direction are arranged in a circumferential direction on an outer surface of the combustor liner.

6. The gas turbine combustor according to claim 1,
wherein a plurality of annular reinforcing ribs are arranged in the axial direction on an outer surface of the combustor liner.
